(19) United States
(12) Patent Application Publication
(10) Pub. No.: US 2002/0012468 A1
(43) Pub. Date: Jan. 31, 2002

(54) Document recognition apparatus and method

(75) Inventors: Yuuichi Togashi, Tokyo (JP); Takayasu Tsuchiuchi, Fuchu-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 09/892,465

(22) Filed: Jun. 28, 2001

(30) Foreign Application Priority Data
Jun. 30, 2000 (JP) 2000-200241

(51) Int. Cl. G06K 9/72

(52) U.S. Cl. 382/229

(57) ABSTRACT

This invention provides a camera image recognition apparatus capable of moving a camera to read a wide region of a document at a high precision and easily correcting an erroneously recognized portion. The shift amount of the character string image of a document image to be compared is calculated for each sensed document image from the character string image of a specific document image among a plurality of sensed document images. When the calculated shift amount reaches a predetermined amount, a new character image in the character string image of a document image whose shift amount reaches the predetermined amount is composited to the character string image of the specific document image, thereby generating a document image.

### CROSS-REFERENCE TO RELATED APPLICATIONS

This application is based upon and claims the benefit of priority from the prior Japanese Patent Application No. 2000-200241, filed Jun. 30, 2000, the entire contents of which are incorporated herein by reference.

### BACKGROUND OF THE INVENTION

The present invention relates to a document recognition apparatus and method.

Conventionally, OCRs (Optical Character Readers) have widely been known as an apparatus for recognizing characters.

Such an OCR reads a document image by a scanner using a CCD contact image sensor and obtains document data. The image read by the CCD contact image sensor is converted into binary data by binarization processing, character extraction processing, and character normalization. The binary data is converted into character data by matching processing using a character dictionary.

Since a plurality of characters are written in a document, a plurality of successive characters are processed as document data in accordance with a word or document format.

Instead of the OCR, a camera may sense an image to recognize a character in the image. However, the camera CCD originally aims at sensing a moving picture and is lower in resolution than the scanner.

If the camera senses an entire document, each character is downsized to influence the character recognition rate. To prevent this, the camera zooms in on a document and senses it. In this case, however, the number of characters read at once decreases, and the document is difficult to recognize.

A method of sensing and compositing a plurality of images is proposed. By a method adopted for a natural image or the like, a feature in an image is detected, and images are so composited as to make identical portions overlap each other. This image enables character recognition, but a character at the boundary may be misread in the prior art.

If a recognition result is erroneous, the erroneous character is generally selected and corrected with a keyboard or mouse.

When a document is to be recognized by using a conventional OCR, a contact CCD used in a scanner captures an image. A document to be read must be set on a flat table or separately read one by one. Thus, it is difficult to read a character set on paper affixed to a wall, for example.

When a document is recognized by using a camera, the recognition performance is poor because the resolution upon capturing an image by a general TV camera is 640×480 pixels and the data amount per character upon reading an entire image at once is too small.

If the camera zooms in on an image to increase the data amount per character, only an image of a small region can be read, and the number of characters read at once is limited. This obstructs post-processing using Japanese morphological information, resulting in a low recognition rate.

If a plurality of images are composited, a character at the boundary is misread, or separated images are sensed.

To read a character with a camera, the user must operate the camera by hand, and the use of a mouse or keyboard for correcting an erroneous character makes the operation cumbersome.

### BRIEF SUMMARY OF THE INVENTION

The present invention has been made in consideration of the above situation, and has as its object to provide a camera image recognition apparatus capable of moving a camera to read a wide region of a document at a high precision and easily correcting an erroneously recognized portion.

It is another object of the present invention to provide a camera image recognition method capable of moving a camera to read a wide region of a document at a high precision and easily correcting an erroneously recognized portion.

To achieve the above objects, a document recognition apparatus according to the first aspect of the present invention comprises means for continuously sensing part of a document to be recognized, means for calculating for each sensed document image a shift amount of a character string image of a document image to be compared from a character string image of a specific document image among a plurality of sensed document images, and means for, when the calculated shift amount reaches a predetermined amount, compositing a new character image in a character string image of a document image whose shift amount reaches the predetermined amount, with the character string image of the specific document image, thereby generating a document image.

According to this aspect, a camera can scan an image to obtain the image at a high resolution and read a character. When text is to be read midway along a row, the text can be interactively read by inputting an image up to the midpoint.

A document recognition apparatus according to the second aspect in the first aspect further comprises means for displaying images of some of a plurality of documents which have successively been sensed and are to be recognized.

According to this aspect, an image optimal for composition can be captured in capturing a plurality of images by a camera.

A document recognition apparatus according to the third aspect of the present invention in the first aspect further comprises means for converting the generated document image into first document data, means for displaying the converted first document data, means for, when part of a document to be recognized is zoomed in and sensed by the image sensing means on the basis of the displayed first document data, converting image data of part of the document which has been zoomed in and sensed into second document data, and means for replacing a character of the first document data that is different from the second document data, by a character of the second document data that corresponds to the different character.

According to this aspect, an erroneously recognized character can be easily corrected only by zooming in on part of a document by a camera.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the hardware arrangement of a document recognition apparatus according to the first embodiment of the present invention;

FIG. 2 is a view for explaining capture of an image by the document recognition apparatus according to the first embodiment;

FIG. 3 is a view showing a state in which a camera is moved from left to right with respect to a horizontal writing document to sense the entire document;

FIG. 4 is a flow chart for explaining the operation of the document recognition apparatus according to the first embodiment;

FIG. 5 is a view for explaining vertical projection data;

FIG. 6 is a flow chart for explaining row region detection operation;

FIG. 7 is a view showing row feature projection data;

FIG. 8 is a view for explaining image composition;

FIG. 9 is a view for explaining determination of vertical writing and horizontal writing documents;

FIG. 10 is a view for explaining determination of vertical and horizontal writing documents;

FIG. 11 is a view showing an example of compositing and displaying four images;

FIG. 12 is a view showing an entire document;

FIG. 13 is a view showing a recognition result;

FIG. 14 is a view showing an image sensing region to be zoomed in;

FIG. 15 is a view showing an image which is zoomed in and captured;

FIG. 16 is a view for explaining a case wherein erroneously recognized characters “third” are replaced by characters “third”; and

FIG. 17 is a flow chart for explaining the operation of a document recognition apparatus according to the third embodiment of the present invention.

### DETAILED DESCRIPTION OF THE INVENTION

Embodiments of the present invention will be described in detail below with reference to the several views of the accompanying drawing.

<First Embodiment>

FIG. 1 is a block diagram showing the arrangement of a document recognition apparatus according to the first embodiment of the present invention.

As shown in FIG. 1, the document recognition apparatus of the first embodiment comprises a camera 1, A/D converter 2, image memory 3, D/A converter 4, display 5, and CPU 6.

The camera 1 senses a document as an object, and outputs document image data representing the sensed document to the A/D converter 2 and display 5. The camera 1 may be a TV camera for sensing a moving picture or a still camera for photographing a still picture.

The A/D converter 2 converts document image data output from the camera 1 into a digital signal, and outputs the digital signal to the image memory 3.

The image memory 3 stores the document image data output from the A/D converter 2. More specifically, the image memory 3 stores a plurality of images successively sensed by the camera 1, and stores a master document image and a document image to be compared (to be described later).

The D/A converter 4 converts the document image data stored in the image memory 3 into an analog signal, and outputs the analog signal to the display 5.

The display 5 displays the document image data output from the D/A converter 4 and a document image output from the camera 1.

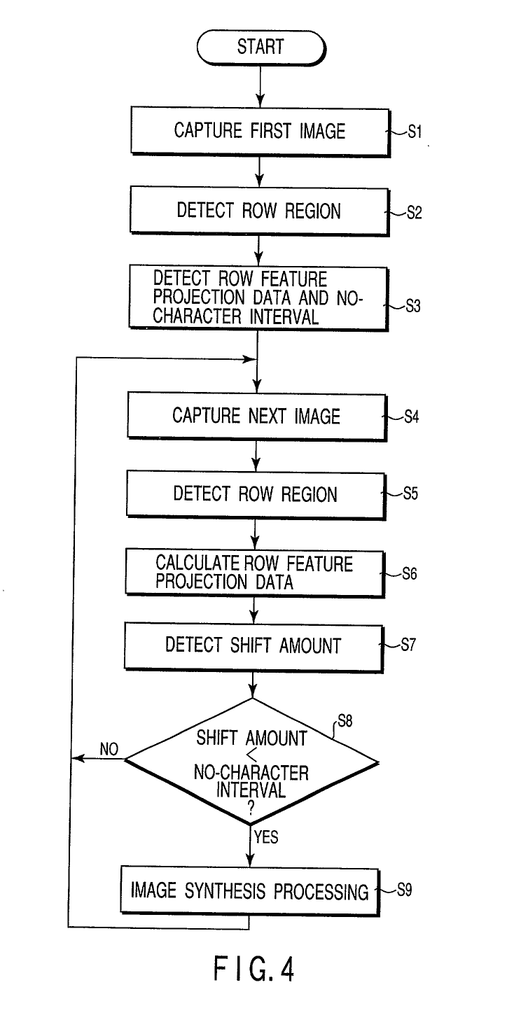

The CPU 6 controls the overall apparatus including the A/D converter 2, image memory 3, and D/A converter 4. More specifically, the CPU 6 performs processes in flow charts shown in FIGS. 4, 6, and 17.

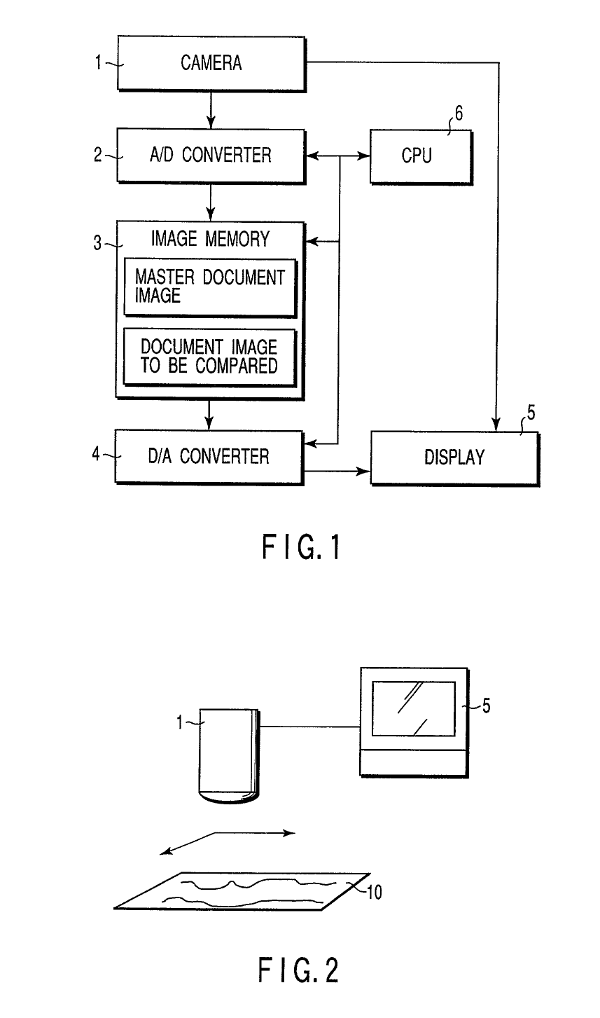

When the document recognition apparatus captures an image in the first embodiment, the camera 1 is moved parallel to an object 10 bearing a document and captures successive images, as shown in FIG. 2. The successive images are composited to generate an image, and the written characters or text is read.

The operation of the document recognition apparatus according to the first embodiment of the present invention will be described with reference to the flow chart of FIG. 4.

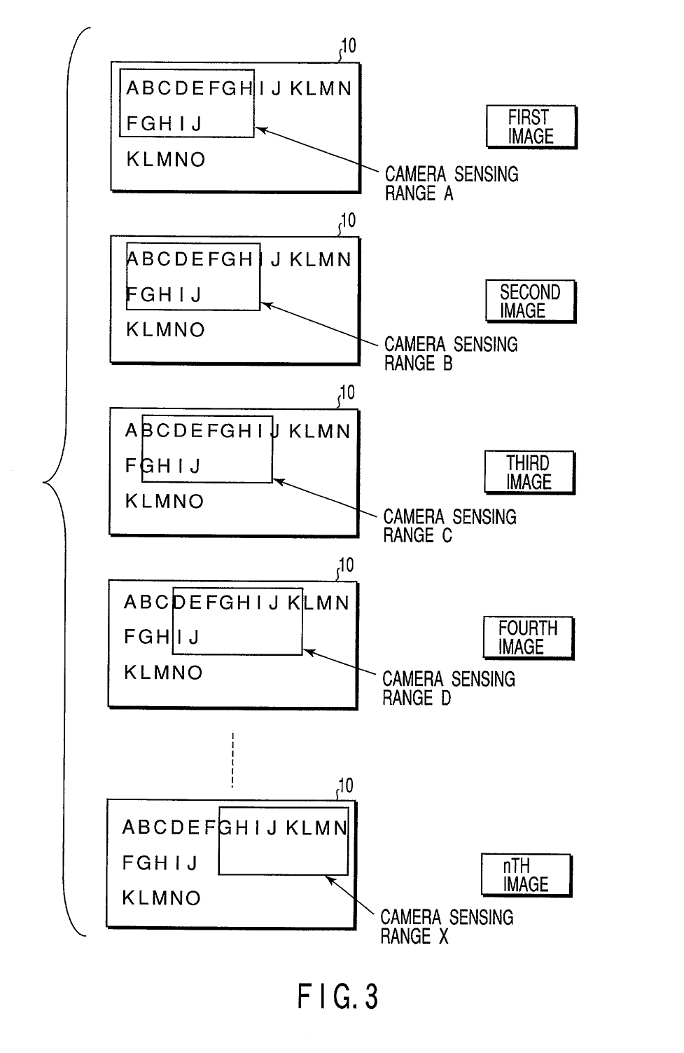

The user holds the camera 1 and senses text written on a document. FIG. 3 shows a state in which the camera 1 is moved from left to right with respect to the document 10 and senses the entire document.

FIG. 3 shows the first to nth images in camera sensing ranges 1 to X. Images in the camera sensing ranges that are sensed by the camera 1 are converted by the A/D converter 2 into digital signals, which are sequentially stored in the image memory 3.

The first image is captured when the image sensing operation of the camera 1 is performed in parallel with the object of the document 10 (S1). In the example of FIG. 3, an image in the leftmost camera sensing range A on the document 10 is captured.

The first image serves as a master document image, and calculation of a shift amount and image synthesis processing (to be described later) are performed by using the master document image as a reference. In the first embodiment, the first document image serves as a master document. The master document means a reference image, is not limited to the first image, and can be an arbitrary image.

The row region of the captured first document (master document) is detected (S2).

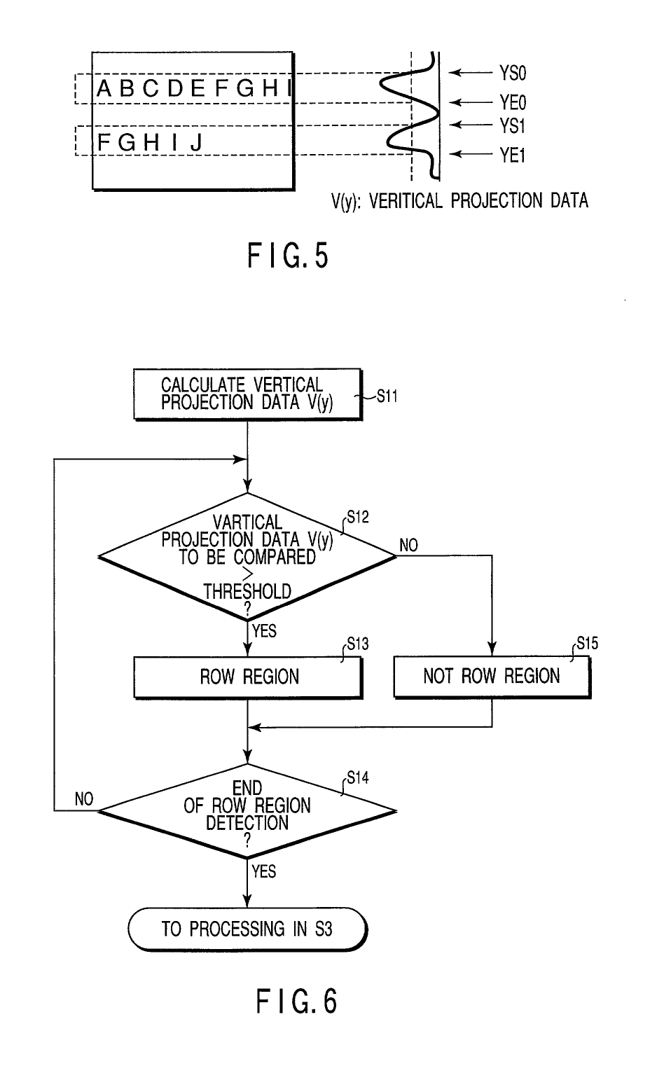

Detection of the row region will be explained with reference to FIGS. 5 and 6.

Vertical projection data V(y) of the captured first document (master document) is calculated (S11).

The vertical projection data V(y) is calculated by adding luminance data in the row direction (along the V axis), as shown in FIG. 5. As shown in FIG. 5, the graph exhibits a crest at a row position because of a large amount of character data, and a trough at the spacing between rows because of a small amount of character data.

The vertical projection data V(y) is given by

$$V ( y ) = {\sum }_{x = 0}^{n} Pix ( x , y ) \qquad ( 1 )$$

where Pix(x,y) is the luminance value at a position defined by X and y coordinates.

Whether vertical projection data V(y), e.g., vertical projection data V(0) out of the calculated vertical projection data V(y) is larger than a predetermined threshold is checked (S12).

If YES in S12, this portion is determined to be a row region; if NO, determined not to be a row region (S15).

Whether detection of the row region has ended is checked (S14). More specifically, row region detection processing ends when determination of a row region is performed for all the calculated vertical projection data V(y) in the y direction. In FIG. 5, portions between YS0 and YE0 and between YS1 to YE1 are rows.

In S3, the row feature projection data of the obtained row regions are calculated. The row feature projection data are used for matching with the second and subsequent document image data. Further, a no-character interval is obtained based on the calculated row feature projection data.

The “no-character interval” has a concept similar to a character interval. The character interval is the interval between characters, whereas the no-character interval is an interval between portions (blank portions) not having any character.

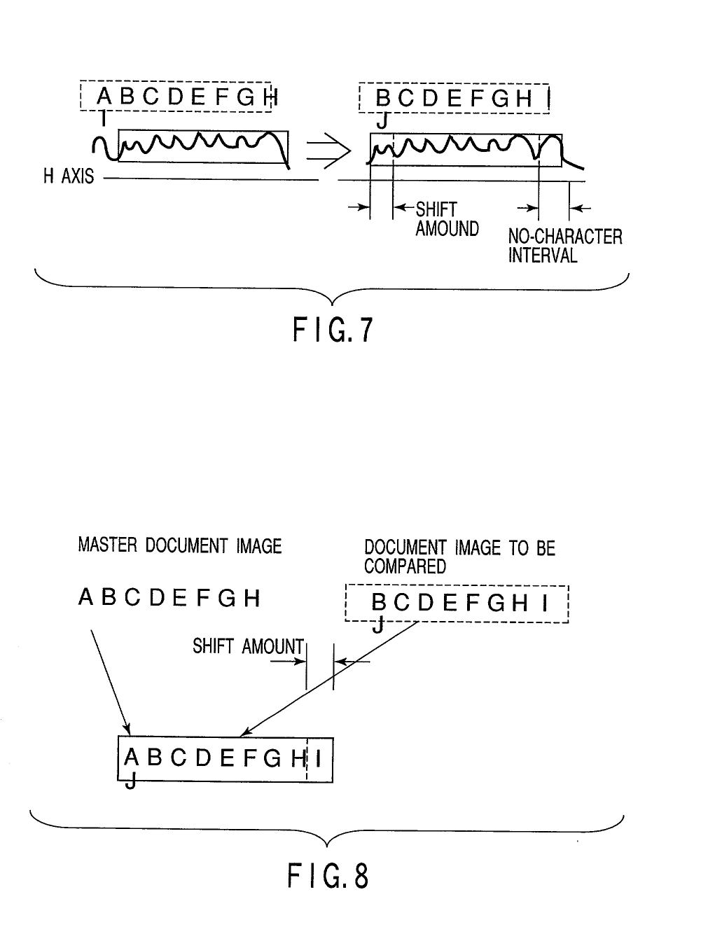

As shown in FIG. 7, the row feature projection data is obtained by adding pixel data to an image of one row perpendicularly to the row direction. The A/D converter A/D-converts data with successive values such that 255 represents a black pixel and 0 represents a white pixel. Row feature projection data attained by adding data at a black portion, i.e., a character portion forms a crest, and row feature projection data at a white portion, i.e., a no-character portion forms a trough. Such data is obtained for each detected row. A no-character interval is calculated based on the obtained row feature projection data.

The row feature projection data is given by

$$Proj ( n , x ) = {\sum }_{y = {YS}_{n}}^{{YE}_{n}} Pix ( x , y ) \qquad ( 2 )$$

Then, the next image (second document image) is captured (S4). The row region of the captured next document image is detected (S2). Row region detection processing is the same as the processing described in S2.

Row feature projection data is calculated from the detected row region (S6). Row feature projection data calculation processing is the same as processing described in S3.

A shift amount representing the shift between the first document image (master document image) and the captured document image (document image to be compared) is calculated.

Note that the master document is the first document image in this example, but is not limited to the first document image and may be any document image serving as a reference.

The shift amount is calculated from row feature projection data obtained from the master document image and row feature projection data obtained from the document image to be compared.

More specifically, matching processing is done for the row feature projection data obtained from the master document image while the row feature projection data obtained from the document image to be compared is shifted.

If the camera moves by +X pixels and senses an image, these row feature projection data match when the document image to be compared is shifted by -X pixels. In this description, matching processing is done by shifting the document image to be compared. Alternatively, the row feature projection data of the document image to be compared may undergo matching processing by shifting row feature projection data obtained from the master document image.

In matching processing, the difference between each frequency of the row feature projection data of the master document image (row feature projection data value) and that of the document image to be compared (row feature projection data value) is added. When the calculated value is the smallest, a match is determined.

The difference in matching processing is calculated by

$$D1st = min ( {\sum }_{p} proj ( n , x - p ) - proj ( n + 1 , x ) ) \qquad ( 3 )$$

If the row feature projection data of the master document image matches that of the document image to be compared, a shift amount is detected from the shift amount of the document image to be compared (or master document image) in matching (S7).

Whether the detected shift amount is larger than a no-character interval is determined (S8). If NO in S8, the flow shifts to processing in S4, and a shift amount is detected for the next image. The no-character interval is obtained from the interval between the troughs of row feature projection data, as shown in FIG. 7.

If YES in S8, the flow shifts to image synthesis processing (S9). Image synthesis processing will be explained.

FIG. 8 shows image composition. At this time, an image is rendered by superimposing a new image on the master document image. At the overlapping portion, a clearer image is used by calculating whether the image is in focus.

In FIG. 8, a character “I” is synthesized on the master document image.

An image may be input with a shift along the V axis. This shift can be detected by obtaining a projection waveform shift upon reception of projection data along the V axis. As an easy method, the shift can be attained from the difference between values XE0, XE1, YB0, and YB1. As a strict method, matching is done for two V-axis projection data.

The matching method executes the same processing as the above-mentioned row feature projection data matching. If this shift is smaller than a predetermined value, images can be composited by ignoring the shift. If the shift is the predetermined value or more, images are composited by correcting the shift. If the shift is too large to correct, a warning that images cannot be composited is issued.

In the first embodiment, the camera 1 is moved from left to right, or the document 10 is moved from right to left. The same processing can also be applied when the camera 1 is moved from right to left or the document 10 is moved from left to right.

The first embodiment has exemplified a horizontal writing document. For a vertical writing document, images can be composited by the same processing by sensing the document while moving the camera from top to bottom or from bottom to top.

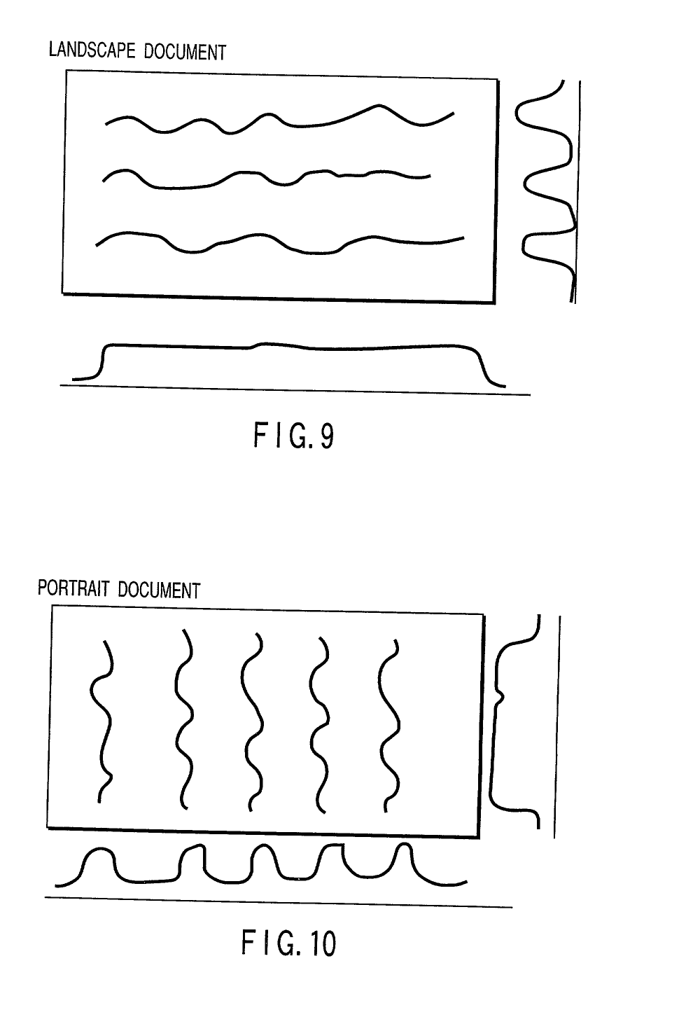

Whether a document is a horizontal writing or vertical writing document is recognized by obtaining projection data of the entire frame along V and H axes and determining the amplitude of the wave, as shown in FIGS. 9 and 10.

To read characters in only a specific range in the first embodiment, the camera can be moved within only this range to interactively recognize characters while checking the composited image. <Second Embodiment>

The second embodiment of the present invention will be described.

A document recognition apparatus of the second embodiment composites and displays images sensed by a camera in the document recognition apparatus of the first embodiment.

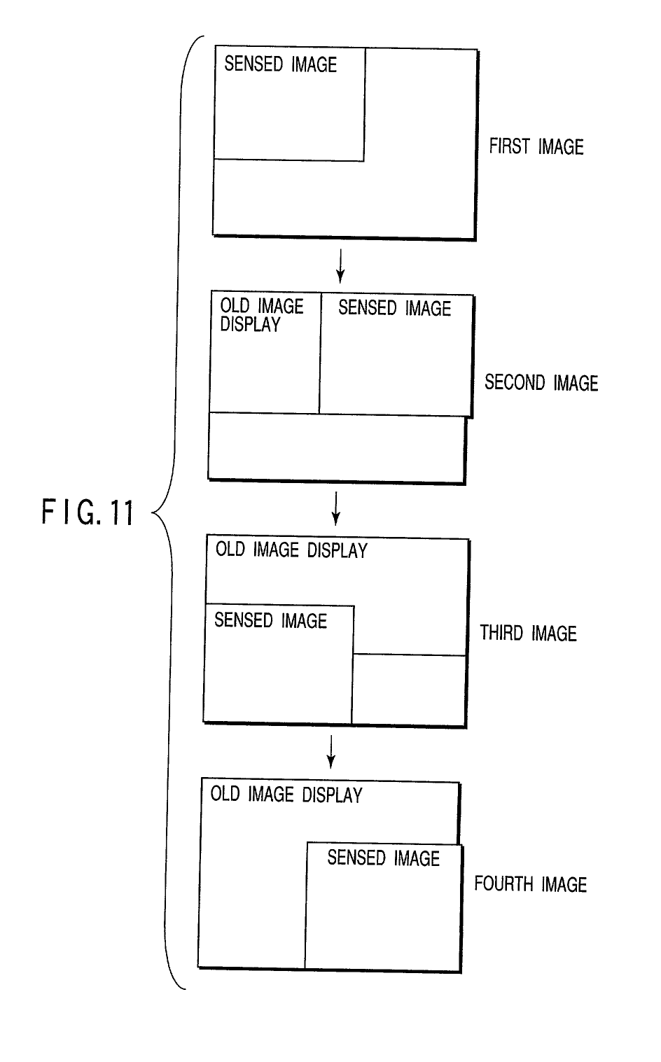

FIG. 11 shows an example of compositing and displaying four images. In image composition, an image which has already been sensed is read out from an image memory 3 and displayed on a display 5 via a D/A converter 4. At the same time, a newly sensed image is displayed as a reference for a sensed image.

The document recognition apparatus of the second embodiment can display an image which has already been sensed. In moving the camera, the user can sense an image while referring to a displayed image. <Third Embodiment>

When some characters of a character string are erroneously recognized, a document recognition apparatus of the third embodiment automatically corrects the characters by zooming in on and sensing the characters, capturing an image again at a high resolution, and recognizing the character again, in addition to the document recognition apparatus of the first embodiment.

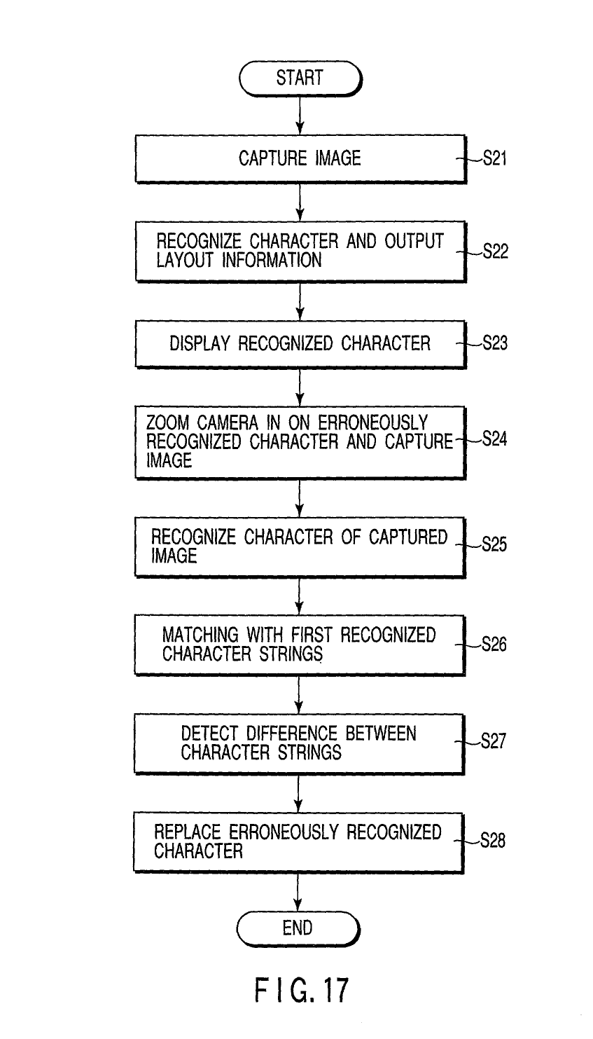

The operation of the document recognition apparatus according to the third embodiment will be described with reference to the flow chart of FIG. 17.

A document image obtained by image synthesis processing is captured (S21). The captured image undergoes character recognition (S22), and a document is formed.

At this time, layout information is also output. This layout information may be output in a format representing that the character on the Nth row and Mth column is “A” or a format representing that the character located×nm from right and Y nm from top is “A”.

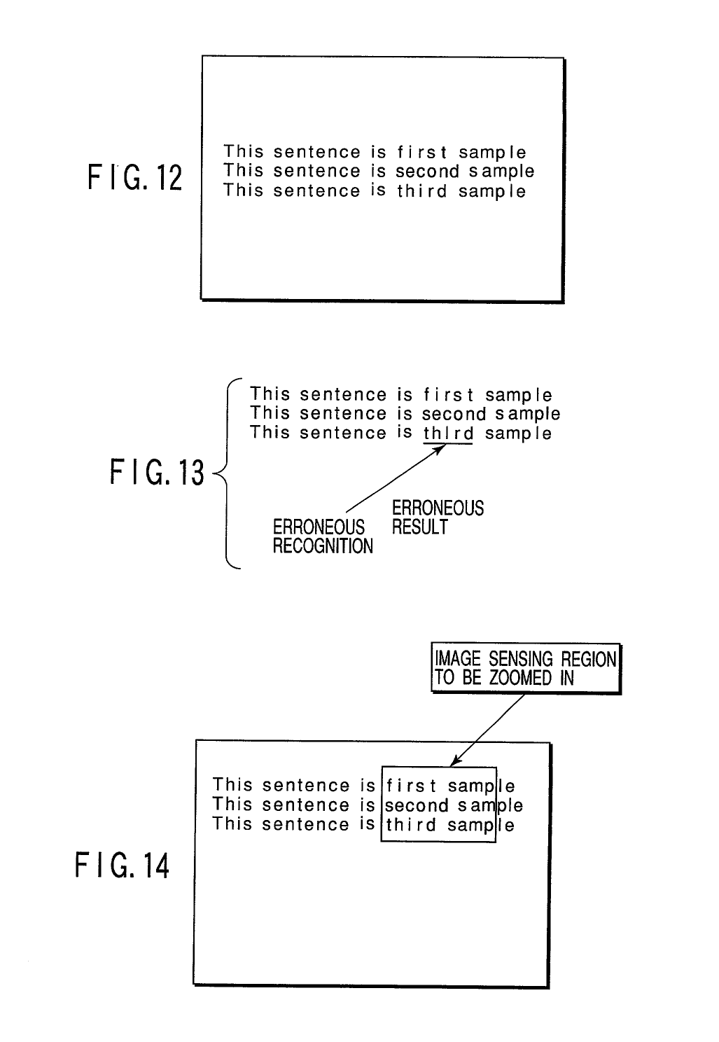

The recognized character is displayed (S23). Assume that the entire document has an image as shown in FIG. 12, and a recognition result as shown in FIG. 13 is obtained and displayed. In this case, characters “third” are erroneously recognized as “third”.

The user checks the displayed recognition result, recognizes the erroneously recognized character, zooms in on the erroneously recognized character by moving the camera close to the erroneously recognized position or operating the lens, and captures an image (S24).

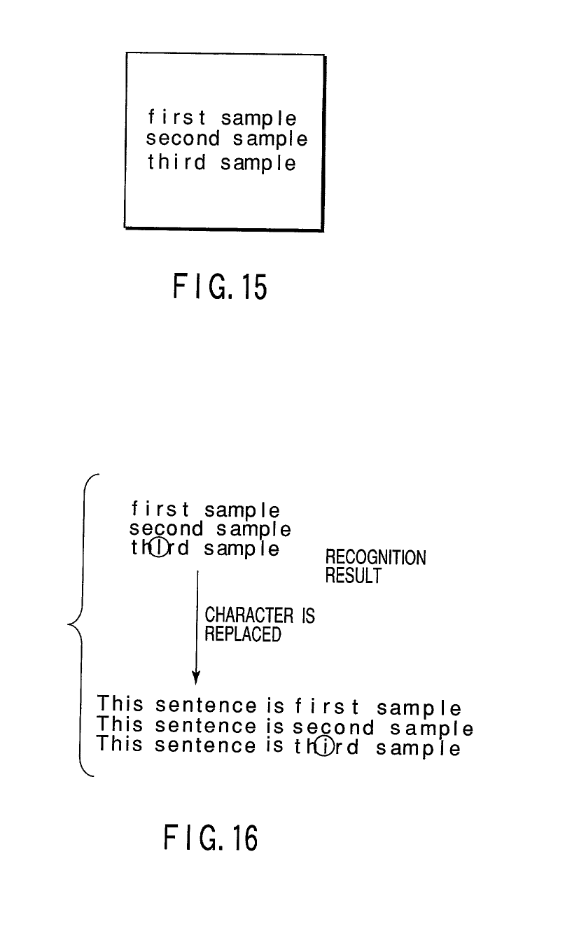

FIG. 14 is a view showing an image sensing region to be zoomed in, and FIG. 15 is a view showing an image which is zoomed in and captured.

The captured image undergoes character recognition (S25) and matching processing with the first recognized character string (S26). The second character region among the first recognized characters is obtained from the matching result and layout information. The characters do not completely match because of the erroneously recognized character information, but the positions of the remaining characters should match.

The difference between the first recognized character string and the character string recognized from the image which is zoomed in and sensed is detected (S27), and the erroneously recognized character is replaced (S28). FIG. 16 is a view for explaining a case wherein the erroneously recognized characters “third” are replaced by characters “third”.

Hence, the image recognition apparatus of the third embodiment can easily correct an erroneously recognized character by the camera zooming in on the erroneously recognized document image.

The present invention is not limited to the above embodiments, and can be variously modified within the spirit and scope of the invention. The embodiments can be appropriately combined. In this case, combined effects can be obtained.

Each embodiment includes inventions of various stages, and various inventions can be extracted by a proper combination of a plurality of building components. For example, when an invention is extracted by eliminating several building components from all those described in the embodiment, the eliminated part is properly compensated for by a known conventional technique in practicing the extracted invention.

The method described in each embodiment can be stored as a program (software means) executable by a computer in a recording medium such as a magnetic disk (floppy disk, hard disk, or the like), optical disk (CD-ROM, DVD, MO, or the like), or semiconductor memory (ROM, RAM, flash memory, or the like), and transmitted and distributed by a communication medium. The program stored in the medium contains a setting program for installing, in the computer, software means (including not only an execution program but also a table and data structure) to be executed by the computer. The computer which implements the apparatus loads the program recorded on the recording medium, in some cases constructs software means by the setting program, and executes the above-described processing while the operation is controlled by the software means. The recording medium in this specification includes not only a distribution medium but also a recording medium such as a magnetic disk or semiconductor memory arranged in the computer or a device connected via a network.

As has been described in detail above, the present invention can provide a camera image recognition apparatus capable of moving a camera to read a wide region of a document at a high precision and easily correcting an erroneously recognized portion.

The present invention can also provide a camera image recognition method capable of moving a camera to read a wide region of a document at a high precision and easily correcting an erroneously recognized portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document recognition apparatus comprising:
means for continuously sensing part of a document to be recognized;
means for calculating for each sensed document image a shift amount of a character string image of a document image to be compared from a character string image of a specific document image among a plurality of sensed document images; and
means for, when the calculated shift amount reaches a predetermined amount, compositing a new character image in a character string image of a document image of which shift amount reaches the predetermined amount, with the character string image of the specific document image, thereby generating a document image.

2. An apparatus according to claim 1, further comprising means for storing a partial image of the continuously sensed document.

3. An apparatus according to claim 1, wherein said means for calculating the shift amount comprises:
means for obtaining a row region of the document image to be compared where the character string image is present;
means for obtaining row feature projection data representing a luminance feature in the obtained row region; and
means for calculating a shift amount of the character string image of the document image to be compared from the character string image of the specific document image on the basis of row feature projection data of the specific document image and row feature projection data of the document image to be compared.

4. An apparatus according to claim 1, wherein said means for calculating the shift amount comprises:
means for obtaining a column region of the document image to be compared where the character string image is present;
means for obtaining column feature projection data representing a luminance feature in the obtained column region; and
means for calculating a shift amount of the character string image of the document image to be compared from the character string image of the specific document image on the basis of column feature projection data of the specific document image and column feature projection data of the document image to be compared.

5. An apparatus according to claim 1, wherein the predetermined amount is determined on the basis of a shape of row feature projection data of the specific document image.

6. An apparatus according to claim 1, further comprising means for displaying images of some of a plurality of documents which have successively been sensed and are to be recognized.

7. An apparatus according to claim 1, further comprising:
means for converting the generated document image into first document data;
means for displaying the converted first document data;
means for, when part of a document to be recognized is zoomed in and sensed by said image sensing means on the basis of the displayed first document data, converting image data of part of the document which has been zoomed in and sensed into second document data; and
means for replacing a character of the first document data that is different from the second document data, by a character of the second document data that corresponds to the different character.

8. A document recognition method comprising the steps of:
continuously sensing part of a document to be recognized;
calculating for each sensed document image a shift amount of a character string image of a document image to be compared from a character string image of a specific document image among a plurality of sensed document images; and
when the calculated shift amount reaches a predetermined amount, compositing a new character image in a character string image of a document image whose shift amount reaches the predetermined amount, with the character string image of the specific document image, thereby generating a document image.

9. A method according to claim 8, wherein the step of calculating the shift amount comprises:
obtaining a row region of the document image to be compared where the character string image is present;
obtaining row feature projection data representing a luminance feature in the obtained row region; and
calculating a shift amount of the character string image of the document image to be compared from the character string image of the specific document image on the basis of row feature projection data of the specific document image and row feature projection data of the document image to be compared.

10. A method according to claim 8, wherein the step of calculating the shift amount comprises:
obtaining a column region of the document image to be compared where the character string image is present;
obtaining column feature projection data representing a luminance feature in the obtained column region; and
calculating a shift amount of the character string image of the document image to be compared from the character string image of the specific document image on the basis of column feature projection data of the specific document image and column feature projection data of the document image to be compared.

11. A method according to claim 8, wherein the predetermined amount is determined on the basis of a shape of row feature projection data of the specific document image.

12. A method according to claim 8, further comprising the step of displaying images of some of a plurality of documents which have successively been sensed and are to be recognized.

13. A method according to claim 8, further comprising:
converting the generated document image into first document data;
displaying the converted first document data;
when part of a document to be recognized is zoomed in and sensed by said image sensing means on the basis of the displayed first document data, converting image data of part of the document which has been zoomed in and sensed into second document data; and
replacing a character of the first document data that is different from the second document data, by a character of the second document data that corresponds to the different character.
